(19) United States
(12) Patent Application Publication
(10) Pub. No.: US 2026/0368880 A1
(43) Pub. Date: Nov. 19, 2026

(54) EVALUATION DEVICE AND EVALUATION METHOD

(71) Applicant: KABUSHIKI KAISHA TOSHIBA, Kawasaki-shi Kanagawa (JP)

(72) Inventors: Akira KIKITSU, Yokohama Kanagawa (JP); Yoshihiro HIGASHI, Komatsu Ishikawa (JP); Satoshi SHIROTORI, Yokohama Kanagawa (JP); Yoshinari KUROSAKI, Kawasaki Kanagawa (JP)

(73) Assignee: KABUSHIKI KAISHA TOSHIBA, Kawasaki-shi Kanagawa (JP)

(21) Appl. No.: 19/533,533

(22) Filed: Feb. 9, 2026

(30) Foreign Application Priority Data
Apr. 15, 2025 (JP) 2025-066678

(51) Int. Cl. G06T 7/00; H01M 10/42; H04N 23/56

(52) U.S. Cl. CPC G06T 7/001; H01M 10/4285; H04N 23/56; G06T 2207/10152; G06T 2207/30108

(57) ABSTRACT

According to one embodiment, an evaluation device includes a magneto-optical film, a light source, an imager, and a driver. The magneto-optical film includes a first face and a second face. The second face is between an evaluation target and the first face. The light source is configured to irradiate the first face with a first polarized light. The imager includes a first polarizing element and a first imaging element. The first imaging element is configured to image the first face via the first polarizing element in a first operation. The driver is configured to supply a first signal being periodic to the evaluation target in the first operation.

### CROSS-REFERENCE TO RELATED APPLICATIONS

This application is based upon and claims the benefit of priority from Japanese Patent Application No. 2025-066678, filed on Apr. 15, 2025; the entire contents of which are incorporated herein by reference.

### FIELD

Embodiments described herein relate generally to an evaluation device and evaluation method.

### BACKGROUND

For example, the evaluation target is inspected by detecting a magnetic field generated from the evaluation target. Efficient evaluation is desirable.

### BRIEF DESCRIPTION OF THE DRAWINGS

FIG. 1 is a schematic diagram illustrating an evaluation device according to a first embodiment;

FIGS. 2A and 2B are schematic diagrams illustrating evaluation devices according to the first embodiment;

FIG. 3 is a schematic diagram illustrating a part of the evaluation device according to the first embodiment;

FIGS. 4A to 4C are schematic diagrams illustrating the characteristics of the evaluation device according to the first embodiment;

FIGS. 5A to 5C are schematic diagrams illustrating the characteristics of the evaluation device;

FIG. 6 is a schematic diagram illustrating the operation of the evaluation device according to the first embodiment;

FIG. 7 is a schematic diagram illustrating the operation of the evaluation device according to the first embodiment;

FIG. 8 is a schematic diagram illustrating the operation of the evaluation device according to the first embodiment;

FIG. 9 is a schematic diagram illustrating the evaluation device according to the first embodiment;

FIG. 10 is a schematic diagram illustrating an evaluation device according to the first embodiment;

FIG. 11 is a schematic diagram illustrating the evaluation device according to the first embodiment;

FIG. 12 is a schematic diagram illustrating the evaluation device according to the first embodiment;

FIG. 13 is a schematic diagram illustrating an evaluation device according to the first embodiment;

FIGS. 14A to 14C are schematic diagrams illustrating the evaluation device according to the first embodiment;

FIG. 15 is a schematic diagram illustrating the evaluation device according to the first embodiment;

FIG. 16 is a flowchart illustrating an evaluation method according to a second embodiment; and

FIG. 17 is a flowchart illustrating a method for manufacturing an evaluation target according to a third embodiment.

### DETAILED DESCRIPTION

According to one embodiment, an evaluation device includes a magneto-optical film, a light source, an imager, and a driver. The magneto-optical film includes a first face and a second face. The second face is between an evaluation target and the first face. The light source is configured to irradiate the first face with a first polarized light. The imager includes a first polarizing element and a first imaging element. The first imaging element is configured to image the first face via the first polarizing element in a first operation. The driver is configured to supply a first signal being periodic to the evaluation target in the first operation.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

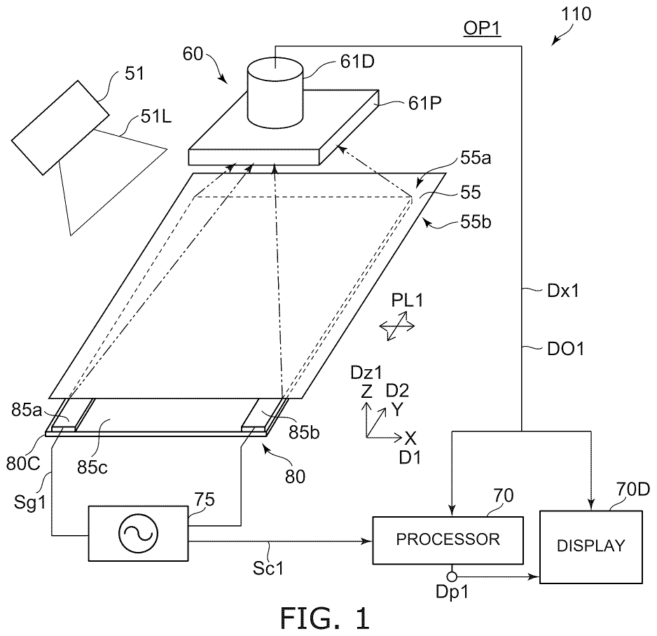

FIG. 1 is a schematic diagram illustrating an evaluation device according to a first embodiment.

As shown in FIG. 1, an evaluation device 110 according to the embodiment includes a magneto-optical film 55, a light source 51, an imager 60, and a driver 75.

The magneto-optical film 55 includes a first face 55a and a second face 55b. The second face 55b is located between an evaluation target 80 and the first face 55a.

The evaluation target 80 may be, for example, an electronic device. For example, the evaluation target 80 includes a first electrode 85a, a second electrode 85b, and an evaluation target region 85c. The evaluation target region 85c is located, for example, between the first electrode 85a and the second electrode 85b. In one example, the evaluation target 80 is a battery 80C. The evaluation target 80 may be, for example, a solar cell. If the evaluation target 80 is a battery 80C, the evaluation target region 85c is a cell portion. If the evaluation target 80 is a solar cell, the evaluation target region 85c is a power generation region.

The driver 75 is configured to supply a first signal Sg1 being periodic to the evaluation target 80 in a first operation OP1. In this example, the evaluation target 80 is a battery 80C. In this case, the first signal Sg1 is a first AC signal supplied between the first electrode 85a and the second electrode 85b. The driver 75 supplies the AC signal as the first signal Sg1 to the evaluation target 80.

The light source 51 is configured to irradiate the first face 55a of the magneto-optical film 55 with a first polarized light 51L. The first polarized light 51L is, for example, linearly polarized light.

The imager 60 includes a first polarizing element 61P and a first imaging element 61D. The first polarizing element 61P is located between the magneto-optical film 55 (first face 55a) and the first imaging element 61D. The first imaging element 61D is configured to capture an image of the magneto-optical film 55 (first face 55a) via the first polarizing element 61P in the first operation OP1.

As described above, in the first operation OP1, the first signal Sg1 being periodic is supplied to the evaluation target 80. A current corresponding to the first signal Sg1 flows between the first electrode 85a and the second electrode 85b. A magnetic field associated with the current is applied to the magneto-optical film 55. Optical characteristics (e.g., magnetization) of the magneto-optical film 55 change due to the magnetic field caused by the current. The change in the optical characteristics is imaged by the imager 60 using the first polarized light 51L. In this embodiment, a state of the evaluation target 80 can be detected all at once by the imager 60. An evaluation device capable of efficient evaluation can be provided.

In a first reference example, the magnetic field generated by the evaluation target 80 is detected by a magnetic field sensor. In this case, for example, the magnetic field sensor is scanned over the evaluation target 80. When inspecting the location of defects in the evaluation target 80 with high spatial resolution, the scanning pitch becomes smaller and the scanning time becomes longer.

In a second reference example, a sensor including an magneto-optical member and a photodetector is scanned over an evaluation target 80 supplied with a direct current. Even in the second reference example, scanning takes a long time.

In contrast, in this embodiment, the first polarized light 51L is used, and the image of the magneto-optical film 55 (first face 55a) is captured by the imager 60 via the first polarizing element 61P. This makes possible to detect the state of a large area of the evaluation target 80 all at once, enabling efficient evaluation.

In the embodiment, for example, an area of the first face 55a (first area) is not less than ½ times an area of the evaluation target 80. For example, the first area may be not less than the area of the evaluation target region 85c.

The magneto-optical film 55 may be substantially in contact with the evaluation target 80. A distance between the magneto-optical film 55 and the evaluation target 80 may be not less than 0.01 mm and not more than 10 mm. For example, the magnetic field from the evaluation target 80 is effectively applied to the magneto-optical film 55. For example, high spatial resolution may be obtained.

As described above, the optical characteristics of the magneto-optical film 55 change due to the magnetic field from the current flowing through the evaluation target 80. The change in optical characteristics is, for example, a change in the polarization state of the light reflected from the magneto-optical film 55. The change in the polarization state includes, for example, a change (rotation) in the plane of polarization. The change in the polarization state may include, for example, a change in the ellipticity of the reflected polarized light.

In the embodiment, the magneto-optical film 55 may include, for example, a rare-earth garnet. The magneto-optical film 55 may include, for example, R—Fe—O, where “R” includes at least one selected from the group consisting of Y, Sm, Eu, Gd, Tb, Dy, Ho, Er, Tm, Yb, and Lu. Highly sensitive changes in optical characteristics are easily obtained.

The magneto-optical film 55 may include, for example, a Heusler alloy. The magneto-optical film 55 may include, for example, PtMnSb. Highly sensitive changes in optical characteristics are easily obtained.

A first image data Dx1 including the imaging results is output from the imager 60. The first image data Dx1 may be supplied to a display 70D or the like. An image including the evaluation results of the evaluation target 80 is displayed on the display 70D. For example, if the evaluation target 80 has a defect, an abnormal current flow occurs around a position of the defect. A localized unusual pattern appears in the image at the position corresponding to the defect. By observing the unusual pattern, the defect or the like can be inspected.

As shown in FIG. 1, the evaluation device 110 may further include a processor 70. The processor 70 may be, for example, an electrical circuit. The processor 70 may be, for example, a computer. The processor 70 may output results of processing the first image data Dx1 obtained from the imager 60. For example, the processor 70 may be configured to process the first image data Dx1 obtained from the imager 60 in synchronized with the first signal Sg1. This results in more accurate evaluation results. The processor 70 may be configured to output a processed data Dp1 obtained by the processing. The processed data Dp1 may be displayed on the display 70D.

As shown in FIG. 1, a control signal Sc1 may be supplied from the driver 75 to the processor 70. The processor 70 may process the first image data Dx1 based on the control signal Sc1. The control signal Sc1 may include information regarding the phase of the first signal Sg1. The processor 70 may process the first image data Dx1 in synchronization with the first signal Sg1 using the control signal Sc1. For, example, the processor 70 may process the first image data Dx1 in synchronization with a period of the first signal Sg1 using the control signal Sc1.

In the embodiment, the processor 70 may supply the control signal Sc1 to the driver 75. The driver 75 may supply the first signal Sg1 being periodic to the evaluation target 80 based on the control signal Sc1.

As shown in FIG. 1, a direction from the second face 55b to the first face 55a is defined as a stacking direction Dz1. The first face 55a crosses the stacking direction Dz1. The first face 55a is along the first plane PL1. The stacking direction Dz1 is defined as a Z-axis direction. A direction perpendicular to the Z-axis direction is defined as an X-axis direction. A direction perpendicular to the Z-axis and X-axis directions is defined as a Y-axis direction. A direction along the first plane PL1 is defined as a first direction D1. A direction being along the first plane PL1 and crossing the first direction D1 is defined as a second direction D2. The first direction D1 may be, for example, the X-axis direction. The second direction D2 may be, for example, the Y-axis direction. The evaluation target 80 may include a face being along the first plane PL1.

Below, several examples of optical systems according to the embodiments will be described.

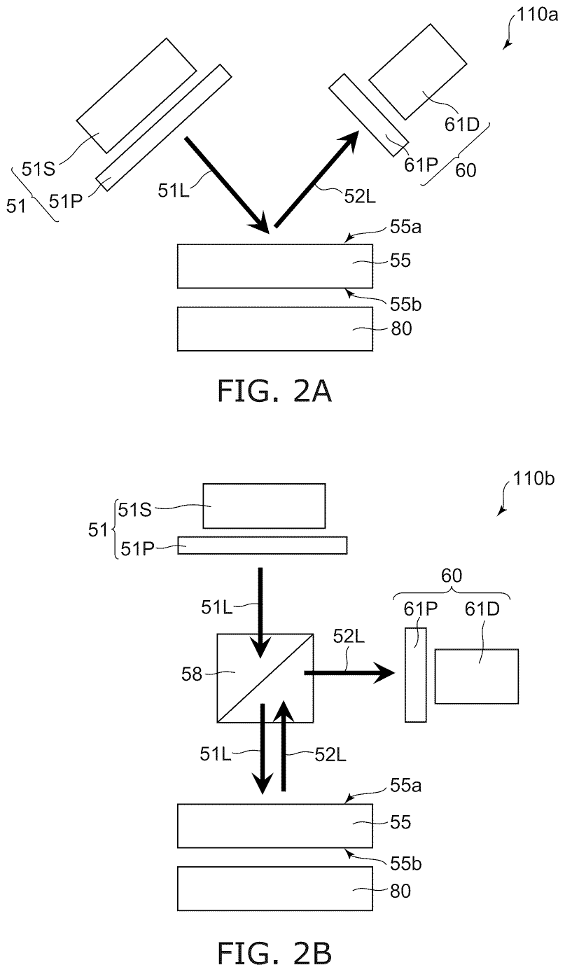

FIGS. 2A and 2B are schematic diagrams illustrating evaluation devices according to the first embodiment.

As shown in FIG. 2A, in an evaluation device 110a according to the embodiment, the light source 51 includes a light emitting portion 51S and a polarizing component 51P. A part of the light emitted from the light emitting portion 51S passes through the polarizing component 51P and becomes the first polarized light 51L. The first polarized light 51L is incident on the first face 55a at an inclined angle with respect to the first face 55a. Light 52L exiting (reflected from, for example) the first face 55a at an inclined angle with respect to the first face 55a is incident on the imager 60.

As shown in FIG. 2B, an evaluation device 110b according to the embodiment further includes an optical element 58. The optical element 58 is, for example, a half mirror. The first polarized light 51L emitted from the light source 51 passes through the optical element 58 and is incident on the magneto-optical film 55. The light 52L reflected from the magneto-optical film 55 is reflected again by the optical element 58 and enters the imager 60. The configurations described above regarding the evaluation device 110a and the evaluation device 110b may be applied to the above evaluation device 110 and various evaluation devices described below.

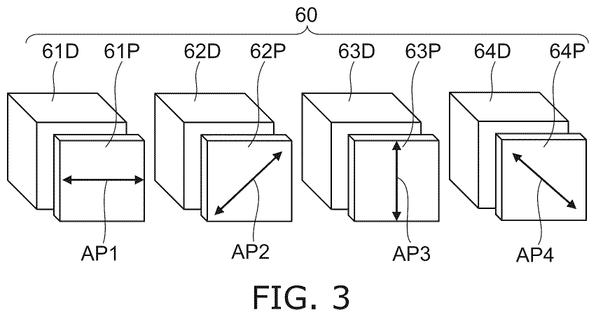

FIG. 3 is a schematic diagram illustrating a part of the evaluation device according to the first embodiment.

As shown in FIG. 3, the imager 60 may include a second polarizing element 62P and a second imaging element 62D in addition to the first polarizing element 61P and the first imaging element 61D. The second imaging element 62D may be configured to capture an image of the first face 55a of the magneto-optical film 55 via the second polarizing element 62P in the first operation OP1. A second polarization direction AP2 of the second polarizing element 62P crosses a first polarization direction AP1 of the first polarizing element 61P. In this example, the angle between the second polarization direction AP2 and the first polarization direction AP1 is substantially 45 degrees. The angle between the second polarization direction AP2 and the first polarization direction AP1 may be variable. The processor 70 may be configured to output the processed data Dp1 (see FIG. 1) based on at least one of a first element data obtained from the first imaging element 61D or a second element data obtained from the second imaging element 62D.

As shown in FIG. 3, the imager 60 may include a third polarizing element 63P and a third imaging element 63D. The third imaging element 63D may be configured to capture an image of the first face 55a of the magneto-optical film 55 via the third polarizing element 63P in the first operation OP1. A third polarization direction AP3 of the third polarizing element 63P crosses the first polarization direction AP1 of the first polarizing element 61P. In this example, an angle between the third polarization direction AP3 and the first polarization direction AP1 is substantially 90 degrees.

As shown in FIG. 3, the imager 60 may include a fourth polarizing element 64P and a fourth imaging element 64D. The fourth imaging element 64D may be configured to capture an image of the first face 55a of the magneto-optical film 55 via the fourth polarizing element 64P in the first operation OP1. A fourth polarization direction AP4 of the fourth polarizing element 64P crosses the first polarization direction AP1 of the first polarizing element 61P. In this example, an angle between the fourth polarization direction AP4 and the first polarization direction AP1 is substantially 135 degrees.

The processor 70 may be configured to output the processed data Dp1 based on the first element data obtained from the first imaging element 61D, the second element data obtained from the second imaging element 62D, a third element data obtained from the third imaging element 63D, and a fourth element data obtained from the fourth imaging element 64D. For example, changes in the polarization state or ellipticity of light reflected from the magneto-optical film 55 may be output.

In the embodiment shown in FIG. 3, one pixel may be formed by a plurality of imaging elements. One pixel may be formed by one of the plurality of imaging elements. One polarization element may be applied to the plurality of imaging elements.

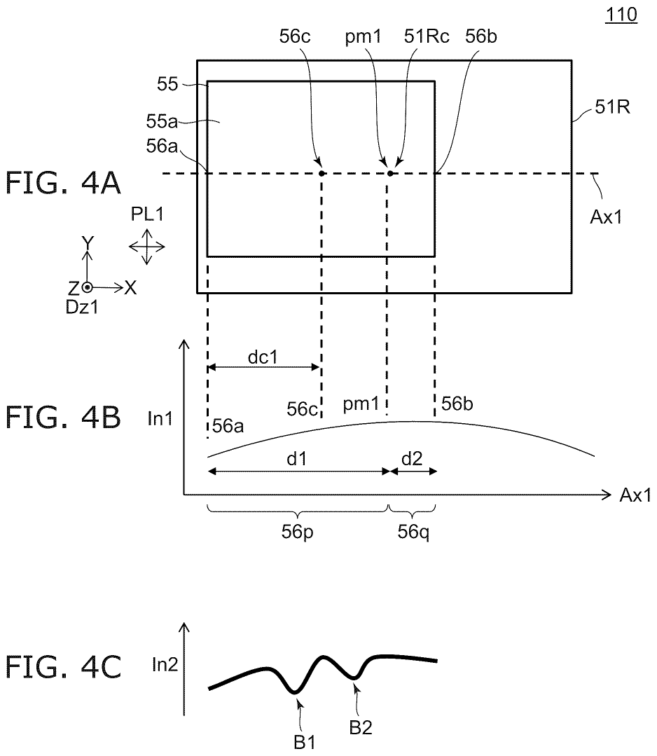

In the embodiment, the processor 70 may be configured to output the processed data Dp1 (see FIG. 1) obtained by accumulating the data from the plurality of first operations OP1. In the embodiment, the intensity of the first polarized light 51L irradiated onto the magneto-optical film 55 may be non-uniform on the first face 55a of the magneto-optical film 55. The intensity of the first polarized light 51L may be non-uniform in at least a part of the first face 55a of the magneto-optical film 55. Abnormal portions (e.g., defects) in the evaluation target 80 can be detected with higher sensitivity. Below, an example of the intensity distribution of the first polarized light 51L is described. FIGS. 4A to 4C are schematic diagrams illustrating the characteristics of the evaluation device according to the first embodiment.

FIG. 4A is a schematic plan view illustrating the characteristics of the first face 55a of the magneto-optical film 55 and the first polarized light 51L. As shown in FIG. 4A, the first face 55a includes two ends (a first end 56a and a second end 56b) on a first axis Ax1 along the first face 55a. The first axis Ax1 may extend in any direction along the X-Y plane.

The first face 55a includes a first center 56c. The first center 56c is the center between the first end 56a and the second end 56b on the first axis Ax1.

FIG. 4B illustrates the intensity distribution of the first polarized light 51L on the first axis Ax1. The horizontal axis in FIG. 4B represents the position on the first axis Ax1. The vertical axis represents the intensity In1 of the first polarized light 51L. As shown in FIG. 4B, in this example, the intensity In1 of the first polarized light 51L is greatest at a maximum intensity position pm1 on the first axis Ax1.

The intensity In1 decreases from the maximum intensity position pm1 toward the first end 56a. In this example, the intensity In1 decreases from the maximum intensity position pm1 toward the second end 56b. The intensity In1 may be highest at one of the two ends.

A distance along the first axis Ax1 between the first end 56a and the maximum intensity position pm1 is defined as a first distance d1. A distance along the first axis Ax1 between the first end 56a and the first center 56c is defined as a center distance dc1. The first distance d1 is longer than the center distance dc1. For example, the maximum intensity position pm1, where the intensity In1 of the first polarized light 51L is highest, is shifted from the center (first center 56c) of the first face 55a of the magneto-optical film 55. For example, the intensity In1 decreases monotonically from the maximum intensity position pm1 toward the first end 56a.

As shown in FIG. 4A, the center 51Rc of the irradiation region 51R of the first polarized light 51L on the first axis Ax1 is shifted from the first center 56c.

In this example, the intensity In1 monotonically decreases from the maximum intensity position pm1 toward the second end 56b. A second distance d2 along the first axis Ax1 between the second end 56b and the maximum intensity position pm1 is shorter than the first distance d1.

For example, a width of the first partial region 56p between the first end 56a and the maximum intensity position pm1 is wider than a width of the second partial region 56q between the second end 56b and the maximum intensity position pm1.

In this embodiment, a length of the first partial region 56p, where the intensity In1 monotonically decreases, is longer than half a width of the first face 55a. It has been found that this configuration enables the inspection of the evaluation target 80 with higher sensitivity. This is because abnormal points (defects, etc.) in the evaluation target 80 is detected with higher sensitivity through a local change in the optical characteristics of the magneto-optical film 55 based on the magnetic field distribution from the evaluation target 80 in the first partial region 56p where the intensity In1 changes monotonically.

For example, when the intensity In1 of the first polarized light 51L changes monotonically, local characteristic anomalies (defects) in the evaluation target 80 can be detected with high accuracy. By increasing the width of the region where the intensity In1 of the first polarized light 51L changes monotonically, local characteristic anomalies can be detected with high accuracy. For example, the width of the region where the intensity In1 of the first polarized light 51L changes monotonically is set to be greater than half the width of the magneto-optical film 55.

FIG. 4C illustrates the intensity In2 of the light 52L via the first polarizing element 61P obtained when the first polarized light 51L having the characteristics illustrated in FIG. 4B is irradiated onto the magneto-optical film 55. In this example, a local change in the polarization state of the light 52L (a decrease in intensity In2) due to defects in the evaluation target 80 can be clearly recognized at positions B1 and B2.

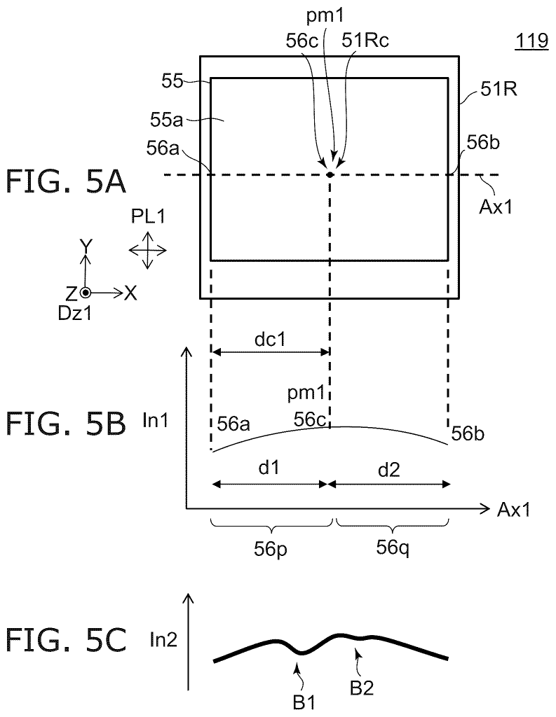

FIGS. 5A to 5C are schematic diagrams illustrating the characteristics of the evaluation device.

As shown in FIGS. 5A and 5B, in an evaluation device 119, the first distance d1 between the first end 56a and the maximum intensity position pm1 is the same as the second distance d2 between the second end 56b and the maximum intensity position pm1. The maximum intensity position pm1 coincides with the first center 56c of the first face 55a. In the evaluation device 119, the length of the region where the intensity In1 monotonically decreases is ½ the width of the first face 55a.

FIG. 5C illustrates the intensity In2 of the light 52L via the first polarizing element 61P obtained when the first polarized light 51L having the characteristics illustrated in FIG. 5B is irradiated onto the magneto-optical film 55. As shown in FIG. 5C, the local decrease in intensity In2 at the position B2 is unclear. In the reference example, it is difficult to detect defects included in the evaluation target 80 by changes in the intensity In1 of the first polarized light 51L.

In contrast, in the embodiment, as described with reference to FIG. 4C, the first partial region 56p, where the first polarized light 51L changes monotonically, is wide, making it possible to clearly recognize defects at both positions B1 and B2. In this embodiment, the width of the first partial region 56p, where the intensity In1 of the first polarized light 51L changes monotonically, is preferably wide. The first distance d1 is preferably 1.2 times or more the center distance dc1. This expands the region where highly accurate detection is possible. The first distance d1 may be 1.5 times or more the center distance dc1. The first distance d1 may be 2 times or more the center distance dc1. In this embodiment, the second distance d2 may be 0.

In the embodiment, processing may include inverting a part of the first image data Dx1 from the imager 60 within the first image data Dx1. An example of the inversion process is described below.

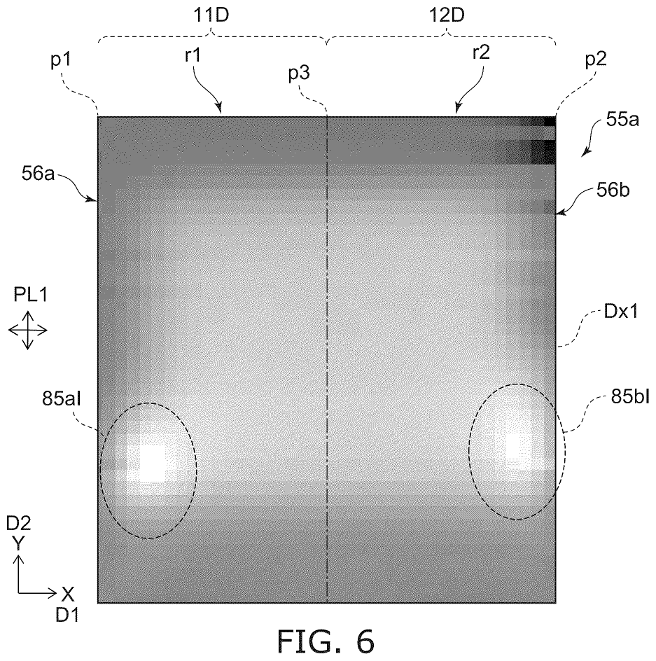

FIGS. 6 to 8 are schematic diagrams illustrating the operation of the evaluation device according to the first embodiment.

FIG. 6 schematically illustrates the first image data Dx1. As shown in FIG. 6, the first image data Dx1 is two-dimensional data. The first image data Dx1 relates to the first plane PL1. The first plane PL1 crosses the stacking direction Dz1. The first plane PL1 includes the first direction D1 and the second direction D2 that crosses the first direction D1.

In FIG. 6, the first image data Dx1 includes images from the first electrode 85a and the second electrode 85b included in the evaluation target 80. In this example, the first image data Dx1 includes a first terminal image 85aI from the first electrode 85a and a second terminal image 85bI from the second electrode 85b.

As shown in FIG. 6, the first image data Dx1 includes a first region data 11D relating to a first region r1 and a second region data 12D relating to a second region r2. The first region r1 corresponds to a part of the region between the first end 56a of the first face 55a and the second end 56b of the first face 55a. The second region r2 corresponds to the region between the first region r1 and the second end 56b. The first direction D1 from the first region r1 to the second region r2 crosses the stacking direction Dz1.

The first image data Dx1 includes, for example, a first position p1, a second position p2, and a third position p3. A direction from the first region r1 to the second region r2 is along the first direction D1. These positions are positions in the first direction D1. The third position p3 is a midpoint between the first position p1 and the second position p2 in the first direction D1. The first position p1 may correspond to the first end 56a. The second position p2 may correspond to the second end 56b.

The first region r1 is located between the first position p1 and the third position p3 in the first direction D1. The second region r2 is located between the third position p3 and the second position p2 in the first direction D1. The first image data Dx1 includes the first region data 11D related to the first region r1 and the second region data 12D related to the second region r2.

The first region data 11D corresponds to data (first light intensity value) in the first region r1 between the first position p1 and the third position p3. The second region data 12D corresponds to data (second light intensity value) in the second region r2 between the third position p3 and the second position p2.

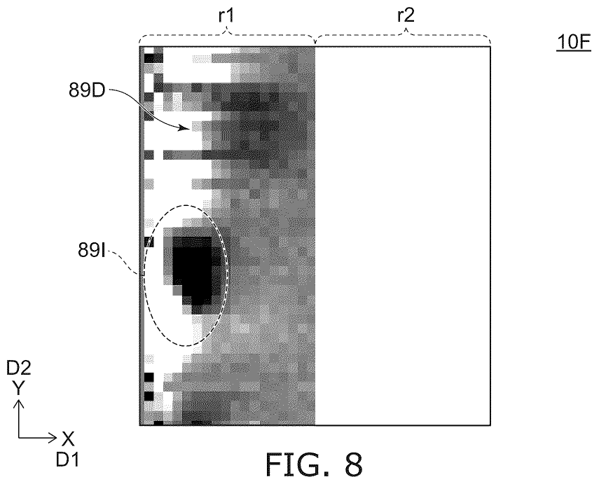

In the first processing operation, the processor 70 may evaluate the evaluation target 80 based on a difference data 10F (see FIG. 8) between the first region data 11D and a second region inverted data 12R, which is obtained by inverting the second light intensity value included in the second region data 12D in the first direction D1. For example, if the difference data 10F has a portion where the value exceeds a threshold, it is evaluated that an abnormal portion (e.g., a defect) exists in the evaluation target 80.

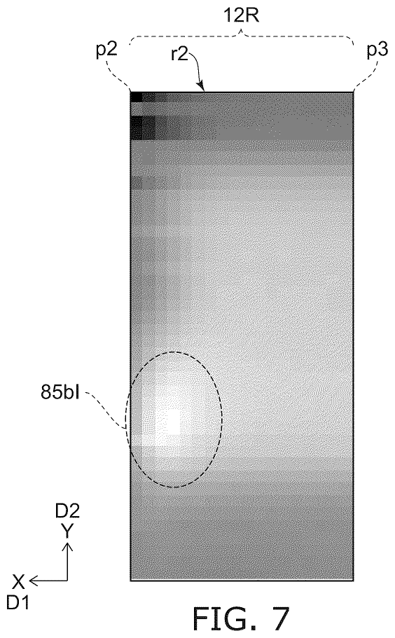

FIG. 7 illustrates an example of the second region inverted data 12R. The second region inverted data 12R is obtained by inverting the second region data 12D illustrated in FIG. 6 in the first direction D1. The difference of this second region inverted data 12R (FIG. 7) and the first region data 11D (see FIG. 6) is included in the difference data 10F (see FIG. 8).

FIG. 8 illustrates an example of the difference data 10F. As already explained, the difference data 10F is the difference between the second region inverted data 12R, which is obtained by inverting the second light intensity value included in second region data 12D in the first direction D1, and the first region data 11D. In FIG. 8, the magnitude of the value of difference data 10F is indicated by the shading of the image.

As shown in FIG. 8, the difference data 10F may include a difference terminal image 89I corresponding to the difference between the first terminal image 85aI and the second terminal image 85bI. Because the difference terminal image 89I is not caused by the body of the evaluation target 80, it may be excluded from the processing for evaluation target 80. For example, the difference terminal image 89I may be removed from difference data 10F.

In FIG. 8, the area excluding the difference terminal image 89I is discussed. In FIG. 8, the value of the difference data 10F is locally large in a part of the region excluding the difference terminal image 89I. This portion corresponds to the position of the defect 89D in the evaluation target 80.

In this way, the first face 55a includes the first end 56a and the second end 56b in one direction (which may be, for example, the first axis Ax1) along the first face 55a. The first image data Dx1 (see FIG. 1) obtained from the imager 60 includes the first region data 11D relating to the first region r1 and the second region data 12D relating to the second region r2. The first region r1 corresponds to a portion between the first end 56a and the second end 56b. The second region r2 corresponds to a portion between the first region r1 and the second end 56b. The first direction D1 from the first region r1 to the second region r2 crosses a direction from the second face 55b to the first face 55a (stacking direction Dz1). The processor 70 may be configured to evaluate the evaluation target 80 based on the processed data Dp1 based on the first image data Dx1. The processed data Dp1 includes the difference data 10F including the difference between the first region data 11D and second region inverted data 12R obtained by inverting the second light intensity values included in the second region data 12D in the first direction D1. By using the second region inverted data 12R, the defect 89D of the evaluation target 80 can be detected with high sensitivity.

The analysis method shown in FIGS. 6 to 8 may be applied to the example described with reference to FIGS. 4A to 4C. In this case, the influence of the maximum intensity position pm1 of the intensity In1 of the first polarized light 51L appears as an anomaly that changes gradually over a wide area in the difference data 10F. This anomaly is not caused by the anomaly in the evaluation target 80, and can be removed from the difference data 10F as background noise. On the other hand, when the analysis method shown in FIG. 6 to 8 is applied to the example described with reference to FIGS. 5A to 5C, the maximum intensity position pm1 of the intensity In1 of the first polarized light 51L is located at the third position p3. As a result, the difference data 10F exhibits a monotonically decreasing contrast, making it impossible to distinguish between an anomaly in the light source 51 and an anomaly in the evaluation target 80. This makes it difficult to detect defects such as defect 89D included in the evaluation target 80.

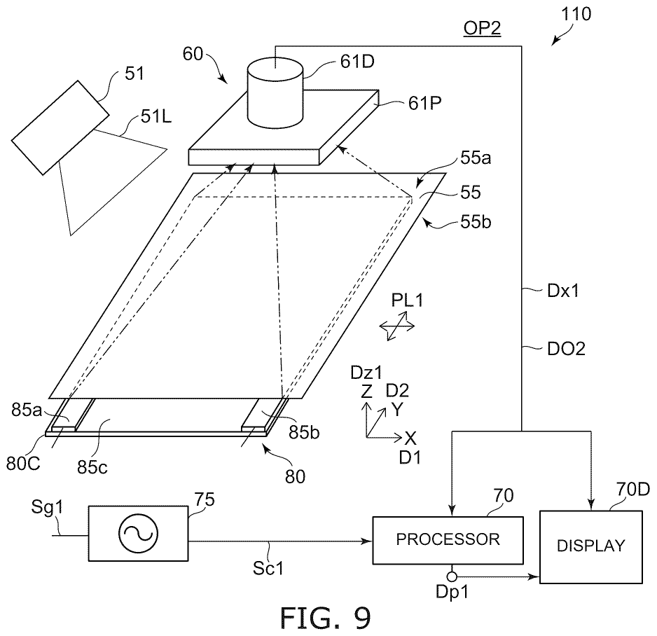

FIG. 9 is a schematic diagram illustrating the evaluation device according to the first embodiment.

As shown in FIG. 9, a second operation OP2 is performed in the evaluation device 110 according to the embodiment. The driver 75 is configured not to supply the first signal Sg1 to the evaluation target 80 in the second operation OP2. As already explained, the driver 75 supplies the first signal Sg1 to the evaluation target 80 in the first operation OP1. The processor 70 obtains a first operation data DO1 obtained from the first imaging element 61D in the first operation OP1 (see FIG. 1). As shown in FIG. 9, the processor 70 obtains a second operation data DO2 obtained from the first imaging element 61D in the second operation OP2. The processor 70 may be configured to output the processed data Dp1 corresponding to a difference between the first operation data DO1 obtained from the first imaging element 61D in the first operation OP1 and the second operation data DO2 obtained from the first imaging element 61D in the second operation OP2. For example, an evaluation result is obtained that excludes information not attributable to the evaluation target 80. For example, evaluation results can be obtained with the influence of geomagnetism suppressed.

For example, the first imaging element 61D may be configured to capture the image of the first face 55a in synchronization with the period of the first signal Sg1 in the first operation OP1. In this case, the first imaging element 61D may be configured to capture the image of the first face 55a in synchronization with the period of the first signal Sg1 even in the case of the second operation OP2. The driver 75 is configured not to supply the first signal Sg1 to the evaluation target 80 in the second operation OP2. The processor 70 may be configured to output the processed data Dp1 corresponding to the difference between first operation data DO1 (see FIG. 1) obtained from the first imaging element 61D in the first operation OP1 and second operation data DO2 obtained from the first imaging element 61D in the second operation OP2.

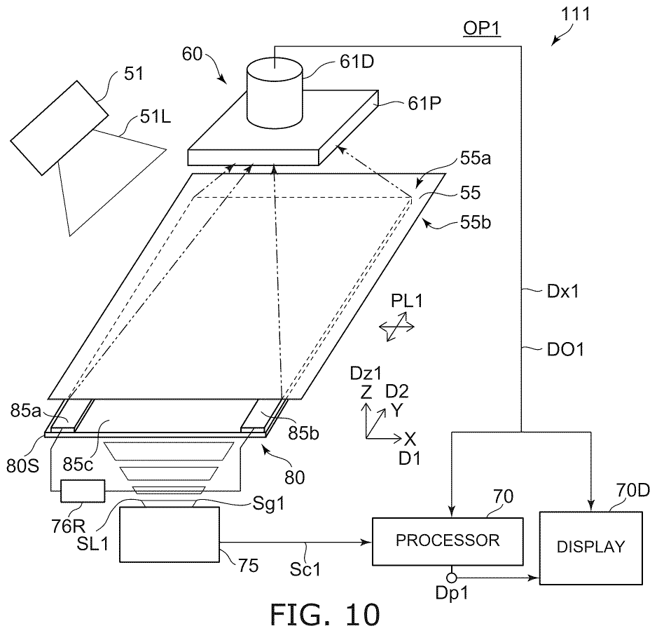

FIG. 10 is a schematic diagram illustrating an evaluation device according to the first embodiment.

As shown in FIG. 10, an evaluation device 111 according to the embodiment includes a resistive member 76R. In the evaluation device 111, a drive light SL1 is irradiated onto the evaluation target 80 as the first signal Sg1. The configuration of the evaluation device 111 except for these may be the same as the configuration of the evaluation device 110 described above. In this example, in the evaluation device 111, the evaluation target 80 is a solar cell 80S. The evaluation target 80 includes a first electrode 85a and a second electrode 85b. In the first operation OP1, the resistive member 76R is electrically connected between the first electrode 85a and the second electrode 85b. In this case, the drive light SL1 generates an electric charge in the evaluation target region 85c, which flows through the resistive member 76R. A change in the magnetic field in response to the flowing electric charge (current) causes a change in the optical characteristics of the magneto-optical film 55. The change in optical characteristics is captured by the imager 60, and the first image data Dx1 is obtained. The processor 70 evaluates the evaluation target 80 based on the first image data Dx1. Abnormalities in the evaluation target 80 can be evaluated.

In this way, in the embodiment, one of the following first condition and second condition may be satisfied. In the first condition, the evaluation target 80 is a battery 80C. In the first condition, the first signal Sg1 is a first AC signal supplied between the first electrode 85a and the second electrode 85b.

In the second condition, the evaluation target 80 is a solar cell 80S. In the second condition, the resistive member 76R is electrically connected between the first electrode 85a and the second electrode 85b, and the first signal Sg1 is the drive light SL1 irradiated onto the solar cell 80S. In the second condition, the driver 75 periodically changes the brightness of the drive light SL1.

The second operation OP2 may also be performed in the evaluation device 111.

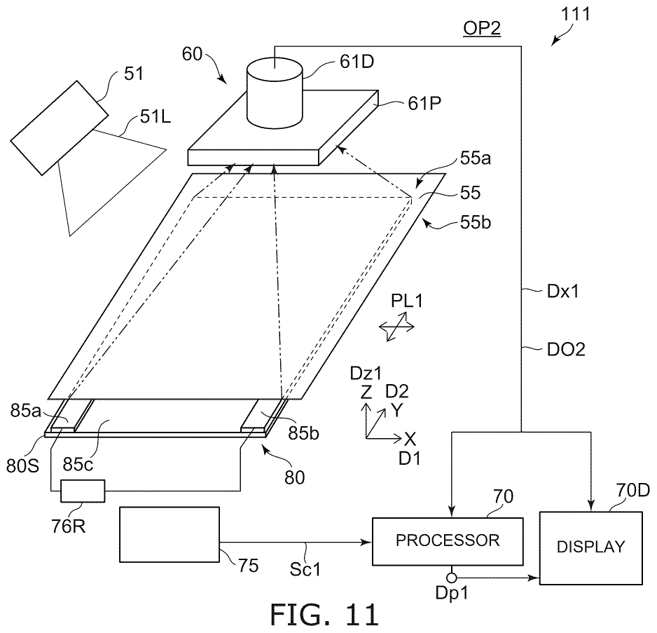

FIG. 11 is a schematic diagram illustrating the evaluation device according to the first embodiment.

In the example shown in FIG. 11, the evaluation target 80 is a solar cell 80S. The second operation OP2 is performed in the evaluation device 111. The driver 75 is configured not to supply the first signal Sg1 (drive light SL1) to the evaluation target 80 in the second operation OP2. As already explained, the driver 75 supplies the drive light SL1 as the first signal Sg1 to the evaluation target 80 in the first operation OP1. The processor 70 obtains the first operation data DO1 from the first imaging element 61D in the first operation OP1 (see FIG. 10). As shown in FIG. 11, the processor 70 obtains the second operation data DO2 from the first imaging element 61D in the second operation OP2. The processor 70 may be configured to output the processed data Dp1 corresponding to the difference between the first operation data DO1 obtained from the first imaging element 61D in the first operation OP1 and the second operation data DO2 obtained from the first imaging element 61D in the second operation OP2. For example, an evaluation result in which the characteristics not attributable to the evaluation target 80 is suppressed is obtained. For example, the influence of geomagnetism is suppressed.

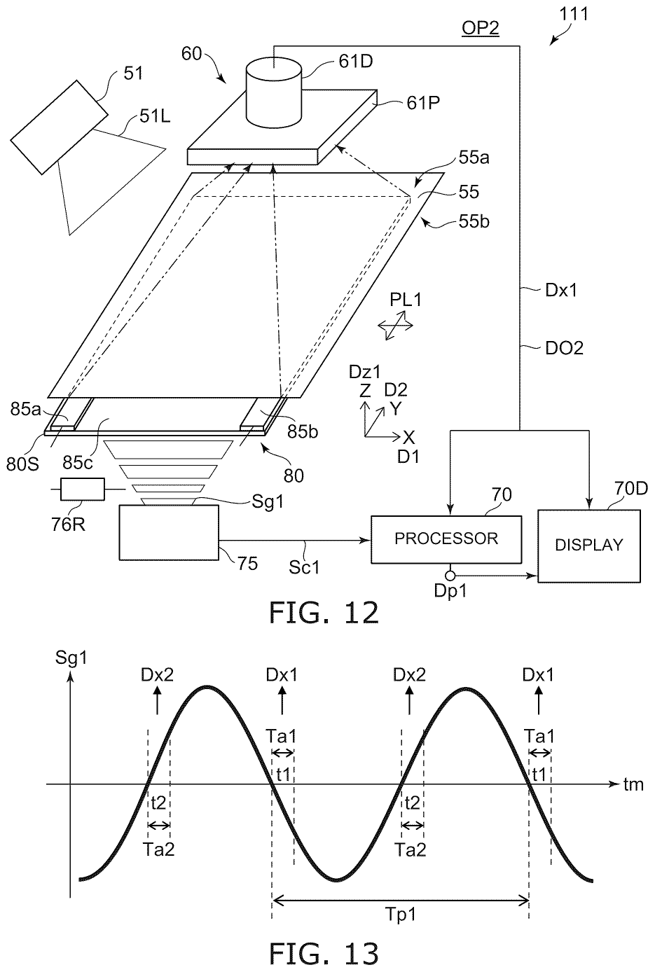

FIG. 12 is a schematic diagram illustrating the evaluation device according to the first embodiment.

In the example shown in FIG. 12, the evaluation target 80 is a solar cell 80S. The evaluation device 111 performs the second operation OP2. In the second operation OP2, the resistive member 76R is not connected between the first electrode 85a and the second electrode 85b. The processor 70 may be configured to output the processed data Dp1 corresponding to the difference between the first operation data DO1 obtained from the first imaging element 61D in the first operation OP1 and the second operation data DO2 obtained from the first imaging element 61D in the second operation OP2. For example, an evaluation result in which the characteristics not attributable to the evaluation target 80 is suppressed is obtained. For example, the influence of noise emitted from the driver 75 is suppressed.

In the example shown in FIGS. 11 and 12, the first imaging element 61D may be configured to image the first face 55a in synchronization with the period of the first signal Sg1 in the first operation OP1. In this case, the first imaging element 61D may be configured to image the first face 55a in synchronization with the first signal Sg1 in the second operation OP2. The driver 75 is configured not to supply the first signal Sg1 (drive light SL1) to the evaluation target 80 in the second operation OP2. The processor 70 may be configured to output processed data Dp1 corresponding to the difference between the first operation data DO1 (see FIG. 1) obtained from the first imaging element 61D in the first operation OP1 and the second operation data DO2 obtained from the first imaging element 61D in the second operation OP2. Evaluation results are obtained that suppress the influence of characteristics not attributable to the evaluation target 80.

In the embodiment, the evaluation target 80 may be any electrical device through which current flows.

Below, several examples of evaluation configurations applicable to the embodiments are described.

FIG. 13 is a schematic diagram illustrating an evaluation device according to the first embodiment.

FIG. 13 corresponds to a first configuration. In the first configuration, imaging is performed in synchronization with the period Tp1 of the first signal Sg1. The horizontal axis of FIG. 13 represents time tm. The vertical axis represents the intensity of the first signal Sg1. If the first signal Sg1 is an AC voltage (AC current), the vertical axis corresponds to the voltage. If the first signal Sg1 is the drive light SL1, the vertical axis corresponds to the intensity of the drive light SL1.

As shown in FIG. 13, the imager 60 captures the first face 55a in a first image capture period Ta1. For example, the imager 60 does not need to capture images in periods other than the first image capture period Ta1. A length of the first imaging period Ta1 may be less than 1/10 of the period Tp1. By capturing an image of a specific state, the first image data Dx1 being stable can be obtained. In this manner, the imager 60 (first imaging element 61D) may be configured to capture an image of the first face 55a in synchronization with the period Tp1 of the first signal Sg1 in the first operation OP1.

Image capture may be performed over a plurality of first imaging periods Ta1. A plurality of imaging data may be accumulated, enabling evaluation with higher sensitivity. The time between the plurality of first imaging periods Tal is an integer multiple the period Tp1. The processor 70 may be configured to output the processed data Dp1 (see FIG. 1) obtained by accumulating the results obtained from the plurality of first operations OP1.

As shown in FIG. 13, the imager 60 (first imaging element 61D) may capture an image of the first face 55a in a second imaging period Ta2. A length of the second imaging period Ta2 may be less than 1/10 of the period Tp1. A period between the center of the first imaging period Ta1 and the center of the second imaging period Ta2 is an odd multiple of ½ of the period Tp1. The phase of the first signal Sg1 in the first imaging period Tal is opposite to the phase of the first signal Sg1 in the second imaging period Ta2. The difference between the first image data Dx1 in the first imaging period Tal and the first image data Dx1 in the second imaging period Ta2 brings results with higher sensitivity. For example, a center time of the first imaging period Ta1 is defined as a first time t1. A center time of the second imaging period Ta2 is defined as a second time t2. A time difference between the first time t1 and the second time t2 is an odd multiple of ½ of the period Tp1. In the first operation OP1, the imager 60 (first imaging element 61D) may be configured to output the first image data Dx1 obtained by imaging the first face 55a in the first imaging period Ta1, which includes the first time t1, and the second image data Dx2 obtained by imaging the first face 55a in the second imaging period Ta2, which includes the second time t2. The processor 70 may be configured to output processed data Dp1 (see FIG. 1) corresponding to the difference between the first image data Dx1 and the second image data Dx2.

Imaging may be performed in a plurality of second imaging periods Ta2. Alternatively, the difference between a sum of the first image data Dx1 obtained by capturing images in the first imaging periods Ta1 and a sum of the second image data Dx2 obtained by capturing images in the second imaging periods Ta2 may be calculated. Evaluation based on the difference can provide more accurate evaluation results.

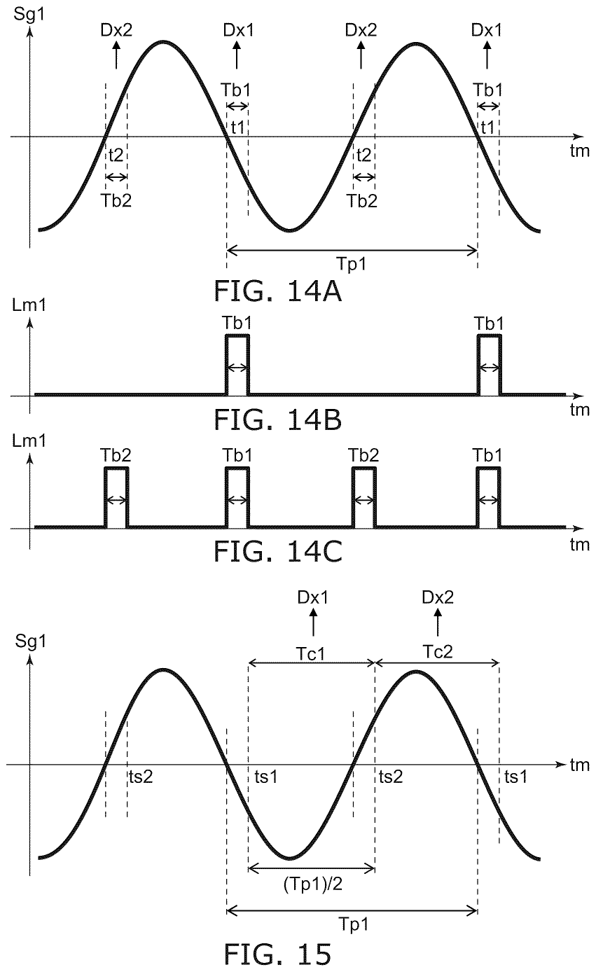

FIGS. 14A to 14C are schematic diagrams illustrating the evaluation device according to the first embodiment.

These figures correspond to a second configuration. In the second configuration, the first polarized light 51L is modulated in synchronization with the period Tp1 of the first signal Sg1. The horizontal axis in these figures represents time tm. The vertical axis in FIG. 14A represents the intensity of the first signal Sg1. The vertical axis in FIGS. 14B and 14C represents the intensity Lm1 of the first polarized light 51L.

As shown in FIG. 14B, the light source 51 emits the first polarized light 51L in a first irradiation period Tb1. A length of the first irradiation period Tb1 may be less than 1/10 of the period Tp1. The first image data Dx1 being stable is obtained by irradiation synchronized with a specific state of the first signal Sg1. In the embodiment, the intensity Lm1 of the first polarized light 51L in the first irradiation period Tb1 may be changed (modulated) from the intensity Lm1 of the first polarized light 51L in periods other than the first irradiation period Tb1. In this manner, the light source 51 may be configured to emit the first polarized light 51L in synchronization with the period Tp1 of the first signal Sg1. Alternatively, the light source 51 may be configured to modulate the intensity Lm1 of the first polarized light 51L in synchronization with the period Tp1 of the first signal Sg1.

The imaging results obtained in a plurality of first irradiation periods Tb1 may be accumulated. A time difference between the plurality of first irradiation periods Tb1 is an integer multiple of the period Tp1.

As shown in FIG. 14C, the first polarized light 51L may be emitted in the second irradiation period Tb2. A length of the second irradiation period Tb2 may be less than 1/10 of the period Tp1. The phase of the first signal Sg1 in the first irradiation period Tb1 is opposite to the phase of the first signal Sg1 in the second irradiation period Tb2. A difference between the first image data Dx1 obtained in the first irradiation period Tb1 and the second image data Dx2 obtained in the second irradiation period Tb2 may be obtained. Evaluation based on the difference allows for more accurate evaluation.

In this way, for example, in the first operation OP1, the light source 51 may be configured to irradiate the first face 55a with the first polarized light 51L in the first irradiation period Tb1 that includes the first time t1, and to irradiate the first face 55a with the first polarized light 51L in the second irradiation period Tb2 that includes the second time t2. The time difference between the first time t1 and the second time t2 is an odd multiple of 1/2 the period Tp1 of the first signal Sg1. The first imaging element 61D may be configured to output the first image data Dx1 obtained by imaging the first face 55a in the first irradiation period Tb1, and the second image data Dx2 obtained by imaging the first face 55a in the second irradiation period Tb2. The processor 70 may be configured to output the processed data Dp1 (see FIG. 1) that corresponds to the difference between the first image data Dx1 and the second image data Dx2.

The difference between the sum of a plurality of imaging results obtained in a plurality of first irradiation periods Tb1 and the sum of a plurality of imaging results obtained in a plurality of second irradiation periods Tb2 may be calculated.

In the example shown in FIG. 14B or FIG. 14C, the second operation OP2 already described may be performed. The first imaging element 61D is configured to capture an image of the first face 55a via the first polarizing element 61P in the second operation OP2. The driver 75 is configured not to supply the first signal Sg1 to the evaluation target 80 in the second operation OP2. Alternatively, the resistive member 76R may not be connected in the second operation OP2. The processor 70 may be configured to output processed data Dp1 (see FIG. 1) corresponding to the difference between the first operation data DO1 obtained from the first imaging element 61D in the first operation OP1 and the second operation data DO2 obtained from the first imaging element 61D in the second operation OP2.

In the examples shown in FIG. 14B and FIG. 14C, the imager 60 may capture images intermittently in synchronization with the irradiation period. In the examples of FIGS. 14B and 14C, the imager 60 may capture images continuously without interlocking with the irradiation period.

FIG. 15 is a schematic diagram illustrating the evaluation device according to the first embodiment.

FIG. 15 corresponds to a third configuration. In the third configuration, the imager 60 captures images in synchronization with the period Tp1 of the first signal Sg1, and the imaging period is ½ of the period Tp1. The horizontal axis of FIG. 15 represents time tm. The vertical axis of FIG. 15 represents the intensity of the first signal Sg1.

As shown in FIG. 15, the first imaging element 61D captures an image of the first face 55a in the first period Tc1. The first period Tc1 is ½ of the period Tp1. The first image data Dx1 obtained from the imager 60 in the first period Tc1 corresponds to the characteristics of the evaluation target 80. By using a period ½ of the period Tp1, the state of the evaluation target 80 can be accurately evaluated.

The first imaging element 61D may image the first face 55a in the second period Tc2. The second period Tc2 is ½ of the period Tp1. The phase of the first signal Sg1 in the second period Tc2 is opposite to the phase of the first signal Sg1 in the first period Tc1. Evaluation may be performed based on the difference between the detection result obtained in the first period Tc1 and the detection result obtained in the second period Tc2. This enables evaluation with higher sensitivity.

In this way, the first imaging element 61D is configured to image the first face 55a via the first polarizing element 61P in the first period Tc1 of the first operation OP1. The first imaging element 61D is configured to image the first face 55a via the first polarizing element 61P in the second period Tc2 of the first operation OP1. The length between the first start time ts1 of the first period Tc1 and the second start time ts2 of the second period Tc2 is an odd multiple of ½ the period Tp1 of the first signal Sg1. The first length of the first period Tc1 and the second length of the second period Tc2 are each ½ the period Tp1 of the first signal Sg1.

The processor 70 may be configured to output the processed data Dp1 (see FIG. 1) corresponding to the difference between the first image data Dx1 obtained from the first imaging element 61D in the first period Tc1 and the second image data Dx2 obtained from the first imaging element 61D in the second period Tc2.

As described above, the third configuration may include a configuration in which the first period Tc1 is used and a configuration in which the first period Tc1 and the second period Tc2 are used. The second operation OP2 may be performed in either of these two configurations. In the second operation OP2, the first imaging element 61D is configured to capture an image of the first face 55a via the first polarizing element 61P. The driver 75 is configured not to supply the first signal Sg1 to the evaluation target 80 in the second operation OP2. Alternatively, the resistive member 76R may not be connected in the second operation OP2. The processor 70 may be configured to output the processed data Dp1 (see FIG. 1) corresponding to the difference between the first operation data DO1 obtained from the first imaging element 61D in the first operation OP1 and the second operation data DO2 obtained from the first imaging element 61D in the second operation OP2.

In the configuration using the first period Tc1, the sum of the plurality of imaging results obtained in the plurality of first periods Tc1 may be derived. In the configuration using the first period Tc1 and the second period Tc2, the difference between the sum of the plurality of imaging results obtained in the plurality of first periods Tc1 and the sum of the plurality of imaging results obtained in the plurality of second periods Tc2 may be derived. In a fourth configuration, the imager 60 continuously captures images over a period longer than the period Tp1. For example, the first image data Dx1 is a video image. The processor 70 is configured to process the image data (first image data Dx1) obtained from the imager 60 in synchronization with the period Tp1 of the first signal Sg1.

In the fourth configuration, for example, the product of the data at each pixel and the amplitude of a sine wave synchronized with the first signal Sg1 is calculated in the imager 60. Image (still image) data synchronized with the period Tp1 may be obtained at each position of the plurality of pixels.

In the fourth configuration, for example, a first product of data obtained at each pixel included in the imager 60 and the amplitude of a sine wave synchronized with the first signal Sg1 is calculated. Meanwhile, a second product of data obtained at each pixel included in the imager 60 and the amplitude of a cosine wave synchronized with the first signal Sg1 is calculated. A calculated result using the first product and the second product may be output at the position of each of the plurality of pixels. Data based on the calculated result may be output from the processor 70 as the processed data Dp1 (see FIG. 1).

### Second Embodiment

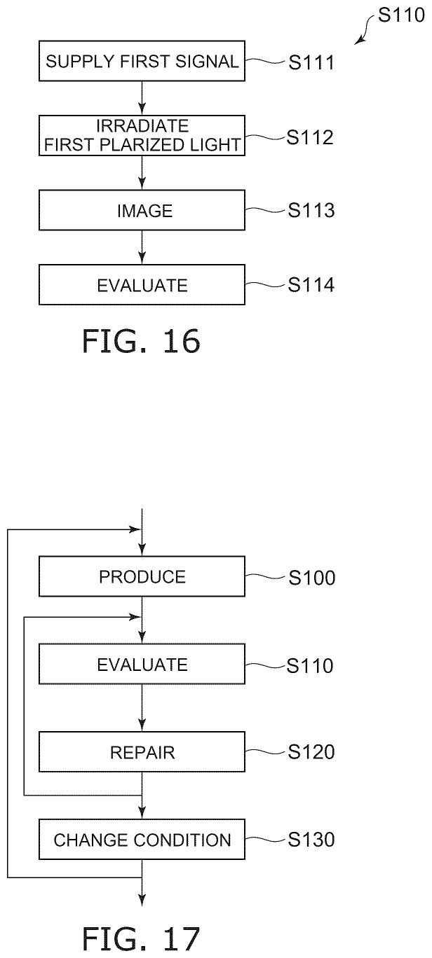

The second embodiment relates to an evaluation method. FIG. 16 is a flowchart illustrating an evaluation method according to the second embodiment.

As shown in FIG. 16, the evaluation method according to the embodiment (step S110) includes the following steps. For example, in the first operation OP1, the first signal Sg1 being periodic is supplied to the evaluation target 80 (step S111). In the first operation OP1, the first polarized light 51L is irradiated onto the first face 55a of the magneto-optical film 55 (step S112). The magneto-optical film 55 includes the first face 55a and the second face 55b. The second face 55b is located between the evaluation target 80 and the first face 55a. In the first operation OP1, the first face 55a is imaged by the first imaging element 61D via the first polarizing element 61P (step S113). The evaluation target 80 is evaluated based on the first image data Dx1 obtained from the first imaging element 61D (step S114).

The evaluation method according to the second embodiment provides an evaluation method capable of efficient evaluation. The various configurations and variations thereof described with respect to the first embodiment may be applied to the second embodiment.

### Third Embodiment

FIG. 17 is a flowchart illustrating a method for manufacturing an evaluation target according to the third embodiment.

As shown in FIG. 17, an evaluation target 80 is produced (step S100). The evaluation target 80 is evaluated using the evaluation method according to the second embodiment (step S110). In the evaluation, the processes described with respect to the first and second embodiments are performed. Highly accurate evaluation can be obtained.

As shown in FIG. 17, repair step may be applied based on the evaluation results (step S120). The evaluation target 80 may be re-inspected after repair.

As shown in FIG. 17, conditions may be changed based on the evaluation results (step S130). For example, the conditions may include the fabrication conditions of the evaluation target 80. For example, the change in conditions may include a change in the material of the evaluation target 80. For example, the change in conditions may include a change in the design of the evaluation target 80. The evaluation method according to the embodiment may be used for defect analysis of the evaluation target 80.

Embodiments may include the following Technical proposals:

### Technical proposal 1

An evaluation device, comprising:
a magneto-optical film including a first face and a second face, the second face being between an evaluation target and the first face;
a light source configured to irradiate the first face with a first polarized light;
an imager including a first polarizing element and a first imaging element, the first imaging element being configured to image the first face via the first polarizing element in a first operation; and
a driver configured to supply a first signal being periodic to the evaluation target in the first operation.

### Technical Proposal 2

The evaluation device according to Technical proposal 1, wherein
a first area of the first face is not less than ½ of an evaluation target region of the evaluation target.

### Technical Proposal 3

The evaluation device according to Technical proposal 1, wherein
the first polarized light is incident on the first face at an inclined angle with respect to the first face, and
a light exiting the first face at an inclined angle with respect to the first face is incident on the imager.

### Technical Proposal 4

The evaluation device according to Technical proposal 1, further comprising:
an optical element,
the first polarized light emitted from the light source passing through the optical element and entering the magneto-optical film, and
the light obtained from the magneto-optical film being reflected by the optical element and entering the imager.

### Technical Proposal 5

The evaluation device according to any one of Technical proposals 1 to 4, wherein
the imager further includes a second polarizing element and a second imaging element,
the second imaging element is configured to capture the first face through the second polarizing element in the first operation,
a second polarization direction of the second polarizing element crosses a first polarization direction of the first polarizing element.

### Technical Proposal 6

The evaluation device according to Technical proposal 5, further comprising:
a processor,
the processor being configured to output a processed data based on at least one of a first-element data obtained from the first imaging element or a second-element data obtained from the second imaging element.

### Technical Proposal 7

The evaluation device according to any one of Technical proposals 1 to 5, wherein
the first imaging element is configured to capture the first face in synchronization with the first signal in the first operation.

### Technical proposal 8

The evaluation device according to Technical proposal 7, further comprising:
a processor,
the processor being configured to output a processed data obtained by accumulating results obtained from a plurality of first operations.

### Technical Proposal 9

The evaluation device according to Technical proposal 7, further comprising:
a processor,
in the first operation, the first imaging element being configured to output an image data obtained by imaging the first face in a first imaging period including a first time and a second image data obtained by imaging the first face in a second imaging period including a second time,
a time difference between the first time and the second time is an odd multiple of ½ of the period, and the processor being configured to output a processed data corresponding to a difference between the first image data and the second image data.

### Technical Proposal 10

The evaluation device according to Technical proposal 9, wherein
the processor is configured to output the processed data obtained by accumulating results obtained from a plurality of first operations.

### Technical Proposal 11

The evaluation device according to any one of Technical proposals 1 to 4, further comprising:
a processor,
in a second operation, the first imaging element being configured to capture an image of the first face in synchronization with the first signal,
the driver being configured not to supply the first signal to the evaluation target in the second operation, and
the processor being configured to output a processed data corresponding to a difference between a first operational data obtained from the first imaging element in the first operation and a second operational data obtained from the first imaging element in the second operation.

### Technical Proposal 12

The evaluation device according to any one of Technical proposals 1 to 4, wherein
the light source is configured to emit the first polarized light in synchronization with the first signal, or to modulate an intensity of the first polarized light in synchronization with the first signal.

### Technical Proposal 13

The evaluation device according to Technical proposal 12 further, comprising:
a processor,
the first imaging element being configured to capture the first face through the first polarizing element in the second operation,
the driver being configured not to supply the first signal to the evaluation target in the second operation, and
the processor being configured to output processed data corresponding to a difference between a first operational data obtained from the first imaging element in the first operation and a second operational data obtained from the first imaging element in the second operation.

### Technical Proposal 14

The evaluation device according to Technical proposal 1, further comprising:
a processor,
in the first operation, the light source being configured to irradiate the first face with the first polarized light in a first irradiation period including a first time and to irradiate the first face with the first polarized light in a second irradiation period including a second time,
a time difference between the first time and the second time being an odd multiple of ½ of a period of the first signal,
the first imaging element being configured to output a first image data obtained by imaging the first face in the first irradiation period and second image data obtained by imaging the first face in the second irradiation period,
the processor being configured to output a processed data corresponding to a difference between the first image data and the second image data.

### Technical Proposal 15

The evaluation device according to Technical proposal 1, further comprising:
a processor,
the first imaging element being configured to image the first face via the first polarizing element in a first period of the first operation,
the first imaging element is configured to image the first face via the first polarizing element in a second period of the first operation,
a length between a first start time of the first period and a second start time of the second period being an odd multiple of ½ a period of the first signal,
each of a first length of the first period and a second length of the second period being ½ a period of the first signal,
the processor being configured to output a processed data corresponding to a difference between a first image data obtained from the first imaging element in the first period and a second image data obtained from the first imaging element in the second period.

### Technical Proposal 16

The evaluation device according to any one of Technical proposals 1 to 4, further comprising:
a processor,
the processor being configured to process a first image data obtained from the imager in synchronization with the first signal.

### Technical Proposal 17

The evaluation device according to Technical proposal 1, wherein
the first face includes a first end and a second end on a first axis along the first face,
a first center is a center of the first end and the second end on the first axis,
an intensity of the first polarized light on the first axis is highest at a maximum intensity position on the first axis,
the intensity decreases from the maximum intensity position toward the first end, and
a first distance along the first axis between the first end and the maximum intensity position is longer than a center distance along the first axis between the first end and the first center.

### Technical Proposal 18

The evaluation device according to Technical proposal 1, further comprising:
a processor,
the first face including a first end and a second end in one direction along the first face,
a first image data obtained from the imager including a first region data relating to a first region and a second region data relating to a second region,
the first region corresponding to a portion between the first end and the second end,
the second region corresponding to a portion between the first region and the second end,
a first direction from the first region to the second region crosses a direction from the second face to the first face,
the processor being configured to evaluate the evaluation target based on a processed data,
the processed data includes a difference between the first region data and a second region inverted data obtained by inverting a plurality of second light intensity values included in the second region data in the first direction.

### Technical Proposal 19

The evaluation device according to any one of Technical proposals 1 to 18, wherein
the evaluation target includes a first electrode, a second electrode, and an evaluation target region between the first electrode and the second electrode,
wherein one of a first condition and a second condition is satisfied,
in the first condition, the evaluation target is a battery, and the first signal is a first AC signal supplied between the first electrode and the second electrode,
in the second condition, the evaluation target is a solar cell, a resistive member is electrically connected between the first electrode and the second electrode, the first signal is a drive light irradiated onto the solar cell, and the driver periodically changes the brightness of the drive light.

### Technical Proposal 20

An evaluation method, comprising:
supplying a first signal being periodic to an evaluation target in a first operation,
irradiating a first face of a magneto-optical film with a first polarized light in the first operation, the magneto-optical film including the first face and a second face, the second face being between the evaluation target and the first face,
imaging the first face by a first imaging element via a first polarizing element in the first operation, and evaluating the evaluation target based on a first image data obtained from the first imaging element.

According to the embodiment, an evaluation device and evaluation method that enable efficient evaluation can be provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the evaluation device such as magneto-optical films, light sources, imagers, drivers, processors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all evaluation devices and all evaluation methods practicable by an appropriate design modification by one skilled in the art based on the evaluation devices and the evaluation methods described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An evaluation device, comprising:
a magneto-optical film including a first face and a second face, the second face being between an evaluation target and the first face;
a light source configured to irradiate the first face with a first polarized light;
an imager including a first polarizing element and a first imaging element, the first imaging element being configured to image the first face via the first polarizing element in a first operation; and
a driver configured to supply a first signal being periodic to the evaluation target in the first operation.

2. The evaluation device according to claim 1, wherein
a first area of the first face is not less than ½ of an evaluation target region of the evaluation target.

3. The evaluation device according to claim 1, wherein
the first polarized light is incident on the first face at an inclined angle with respect to the first face, and
a light exiting the first face at an inclined angle with respect to the first face is incident on the imager.

4. The evaluation device according to claim 1, further comprising:
an optical element,
the first polarized light emitted from the light source passing through the optical element and entering the magneto-optical film, and
the light obtained from the magneto-optical film being reflected by the optical element and entering the imager.

5. The evaluation device according to claim 1, wherein
the imager further includes a second polarizing element
and a second imaging element,
the second imaging element is configured to capture the first face through the second polarizing element in the first operation,
a second polarization direction of the second polarizing element crosses a first polarization direction of the first polarizing element.

6. The evaluation device according to claim 5, further comprising:
a processor,
the processor being configured to output a processed data based on at least one of a first-element data obtained from the first imaging element or a second-element data obtained from the second imaging element.

7. The evaluation device according to claim 1, wherein
the first imaging element is configured to capture the first face in synchronization with the first signal in the first operation.

8. The evaluation device according to claim 7, further comprising:
a processor,
the processor being configured to output a processed data obtained by accumulating results obtained from a plurality of first operations.

9. The evaluation device according to claim 7, further comprising:
a processor,
in the first operation, the first imaging element being configured to output an image data obtained by imaging the first face in a first imaging period including a first time and a second image data obtained by imaging the first face in a second imaging period including a second time,
a time difference between the first time and the second time is an odd multiple of ½ of the period, and
the processor being configured to output a processed data corresponding to a difference between the first image data and the second image data.

10. The evaluation device according to claim 9, wherein
the processor is configured to output the processed data obtained by accumulating results obtained from a plurality of first operations.

11. The evaluation device according to claim 1, further comprising:
a processor,
in a second operation, the first imaging element being configured to capture an image of the first face in synchronization with the first signal,
the driver being configured not to supply the first signal to the evaluation target in the second operation, and
the processor being configured to output a processed data corresponding to a difference between first operational data obtained from the first imaging element in the first operation and a second operational data obtained from the first imaging element in the second operation.

12. The evaluation device according to claim 1, wherein
the light source is configured to emit the first polarized light in synchronization with the first signal, or to modulate an intensity of the first polarized light in synchronization with the first signal.

13. The evaluation device according to claim 12 further, comprising:
a processor,
the first imaging element being configured to capture the first face through the first polarizing element in the second operation,
the driver being configured not to supply the first signal to the evaluation target in the second operation, and
the processor being configured to output processed data corresponding to a difference between a first operational data obtained from the first imaging element in the first operation and a second operational data obtained from the first imaging element in the second operation.

14. The evaluation device according to claim 1, further comprising:
a processor,
in the first operation, the light source being configured to irradiate the first face with the first polarized light in a first irradiation period including a first time and to irradiate the first face with the first polarized light in a second irradiation period including a second time,
a time difference between the first time and the second time being an odd multiple of ½ of a period of the first signal,
the first imaging element being configured to output a first image data obtained by imaging the first face in the first irradiation period and second image data obtained by imaging the first face in the second irradiation period,
the processor being configured to output a processed data corresponding to a difference between the first image data and the second image data.

15. The evaluation device according to claim 1, further comprising:
a processor,
the first imaging element being configured to image the first face via the first polarizing element in a first period of the first operation,
the first imaging element is configured to image the first face via the first polarizing element in a second period of the first operation,
a length between a first start time of the first period and a second start time of the second period being an odd multiple of ½ a period of the first signal,
each of a first length of the first period and a second length of the second period being ½ a period of the first signal,
the processor being configured to output a processed data corresponding to a difference between a first image data obtained from the first imaging element in the first period and a second image data obtained from the first imaging element in the second period.

16. The evaluation device according to claim 1, further comprising:
a processor,
the processor being configured to process a first image data obtained from the imager in synchronization with

17. The evaluation device according to claim 1, wherein
the first face includes a first end and a second end on a first axis along the first face,
a first center is a center of the first end and the second end on the first axis,
an intensity of the first polarized light on the first axis is highest at a maximum intensity position on the first axis,
the intensity decreases from the maximum intensity position toward the first end, and
a first distance along the first axis between the first end and the maximum intensity position is longer than a center distance along the first axis between the first end and the first center.

18. The evaluation device according to claim 1, further comprising:
a processor,
the first face including a first end and a second end in one direction along the first face,
a first image data obtained from the imager including a first region data relating to a first region and a second region data relating to a second region,
the first region corresponding to a portion between the first end and the second end,
the second region corresponding to a portion between the first region and the second end,
a first direction from the first region to the second region crosses a direction from the second face to the first face,
the processor being configured to evaluate the evaluation target based on a processed data,
the processed data includes a difference between the first region data and a second region inverted data obtained by inverting a plurality of second light intensity values included in the second region data in the first direction.

19. The evaluation device according to claim 1, wherein
the evaluation target includes a first electrode, a second electrode, and an evaluation target region between the first electrode and the second electrode,
wherein one of a first condition and a second condition is satisfied,
in the first condition, the evaluation target is a battery, and the first signal is a first AC signal supplied between the first electrode and the second electrode,
in the second condition, the evaluation target is a solar cell, a resistive member is electrically connected between the first electrode and the second electrode, the first signal is a drive light irradiated onto the solar cell, and the driver periodically changes the brightness of the drive light.

20. An evaluation method, comprising:
supplying a first signal being periodic to an evaluation target in a first operation,
irradiating a first face of a magneto-optical film with a first polarized light in the first operation, the magneto-optical film including the first face and a second face, the second face being between the evaluation target and the first face,
imaging the first face by a first imaging element via a first polarizing element in the first operation, and evaluating the evaluation target based on a first image data obtained from the first imaging element.
